(19) United States
(12) Patent Application Publication
(10) Pub. No.: US 2009/0306231 A1
(43) Pub. Date: Dec. 10, 2009

(54) Process for preparing an emulsion

(76) Inventors: Satish Venkata Akella, Waltham, MA (US); David Chandra Franklin, Bangalore (IN); Vijay Mukund Naik, Mumbai (IN); Janhavi Sanjay Raut, Bangalore (IN); Amit Kumar Singh, Gainesville, FL (US); Sambamurthy Jayaraman Suresh, Bangalore (IN); Rajanarayana Venkataraghavan, Bangalore (IN)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/227,243

(22) PCT Filed: May 8, 2007
(86) PCT No.: PCT/EP2007/054451

§ 371 Date: Apr. 28, 2009

(30) Foreign Application Priority Data
May 15, 2006 (IN) 0747/MUM/2006

(51) Int. Cl. B01F 3/08

(52) U.S. Cl. 516/53

(57) ABSTRACT

The invention relates to a process for preparing an emulsion of a first liquid in a second liquid wherein (a) at least one of the liquids comprises a surfactant or a precursor thereof, and (b) said second liquid has an electrical conductivity of less than 100 microSiemens/centimeter, and (c) interfacial tension between said liquids is at least 0.0001 mN/m, and (d) said liquids are subjected to an electric field of strength between 5000 to 10⁷ V/m.

This invention relates to a process for preparing an emulsion.

### BACKGROUND AND PRIOR ART

Processes for preparation of emulsions are of a great deal of commercial interest as a large number of industrial processes involve preparation of emulsions. Other reason of commercial interest is that processes for preparation of emulsion are employed in preparing a variety of consumer products or ingredients thereof including cleaning preparations, food preparations and cosmetic preparations. For example, cosmetic preparations such as skin creams and lotions and food products such as margarine, salad dressings and fat spreads are in form of emulsions and employ processes for preparation of emulsions at initial, final or intermediate stage in their production.

Processes for preparation of emulsion require generation of high interfacial area, an objective that is achieved in conventional emulsification processes by introducing mechanical energy by various means such as agitation by stationary and moving mixing elements, flow of fluids and ultrasonic vibrations. However, these methods of introducing mechanical energy are inefficient as a large fraction of mechanical energy introduced is dissipated in generating bulk liquid flows and in viscous dissipation. Further, the methods employing stationary and moving elements require frequent maintenance and there is a chance of contamination of extraneous material leading to difficulties in standards of quality, hygiene and cleanliness.

Another problem in the conventional processes is that it is particularly difficult to prepare emulsions of sufficiently small droplet size, especially when viscosity of continuous phase is high. A further problem with the conventional processes is that it is difficult to adapt these industrial scale processes to a point of sale manufacture of emulsions.

On the other hand, use of electric fields in various separation processes is known. For example, U.S. Pat. No. 5,262,027 (Martin Marietta Energy Systems, Inc., 1999) describes a method for contacting liquid phases by introducing a first liquid phase through a nozzle into a continuous second liquid phase and applying a vertically oriented pulsed electric field of sufficiently high intensity to the first liquid phase upon exiting the nozzle to shatter the first liquid phase into many micro droplets to form a dispersion which is then subjected to a further pulsed electric field to cause the first liquid phase to undergo continuous coalescence and redispersion, and coalescing the dispersion to separate the phases. This document is thus directed towards providing a high throughput solvent extraction process with increased extraction efficiency, and does not describe a method of preparation of an emulsion.

Thus the prior art does not address the problem of preparation of an emulsion that is energy efficient whilst maintaining high standards of quality, hygiene and cleanliness, and capable of handling highly viscous fluids and capable of producing emulsions that have small droplet size.

Therefore, one of the objects of the present invention is to provide a process for preparation of emulsion that substantially reduces the input of mechanical energy required and is energy-efficient.

A further object of the present invention is to provide a process for preparation of an emulsion that does not use stationary or moving mixing elements thereby reducing risk of contamination of extraneous material and thus helps in achieving high standards in cleanliness, hygiene and quality.

A further object of the present invention is to provide a process for preparation of emulsion where the droplet size of emulsion is small.

A further object of the present invention is to provide a process for preparation of an emulsion of liquids having a high viscosity.

Yet another object of the present invention is to provide a process of preparation of an emulsion that can be adapted to a point of sale manufacture as well as to a centralized mass manufacture.

Further and other objects of the present invention will become apparent from the description contained herein.

### SUMMARY OF THE INVENTION

According to the present invention there is provided a process for preparation of emulsion of a first liquid in a second liquid wherein
(a) at least one of the liquids comprises a surfactant or a precursor thereof, and
(b) said second liquid has an electrical conductivity of less than 100 microSiemens/centimeter, and
(c) interfacial tension between said liquids is between at least 0.0001 mN/m, and
(d) said liquids are subjected to an electric field of strength from 5000 to 10⁷ V/m.

It is preferred that a preformed coarse emulsion or dispersion of said liquids is subjected to said electric field.

The surfactant of the present invention is preferably selected from nonionic, amphoteric or zwitterionic. The surfactant is preferably in the range 0.01-20% by weight of the emulsion.

### DETAILED DESCRIPTION OF THE INVENTION

According to the essential features of the present invention, there is provided a process of preparation of emulsion of two liquids where the interfacial tension between the liquids is at least 0.0001 mN/m by subjecting them to an electric field in presence of a surfactant.

### Emulsion

The present invention provides a process for preparation of an emulsion of a first liquid in a second liquid.

The process of the present invention can be used for preparation of emulsion that can be an oil-in-water type, water-in-oil type or a multiple emulsion type and can be used to prepare any emulsion of commercial interest. The process can be used in preparation of consumer products or ingredients thereof. Such consumer products include cleaning preparations, food preparations and cosmetic preparations. Non-limiting examples of cleaning preparations are fabric-care, oral care and hard surface cleaning preparations. Non-limiting examples of cosmetic preparations include skin creams and lotions, hair care products and the like. Non-limiting examples of food preparations include margarine, salad dressings and fat spreads. The process for preparation of emulsion may be used at an initial, final or intermediate stage in the production of such consumer products. The process according to the present invention may be a part of a downstream process for manufacturing. The process can be used to prepare an emulsion for use as a feedstock for manufacturing consumer products.

In a preferred aspect, the process according to the present invention is used during preparation of an edible emulsion. In a further preferred aspect, such edible emulsion is margarine, fat spread, or a salad dressing or an ingredient thereof.

Process according to the present invention is preferably used for preparation of emulsions wherein the emulsion thus prepared has the volume of the dispersed phase preferably between 0.01-85%, more preferably between 5-50% of the volume of the emulsion. It is particularly preferred that the volume of the dispersed phase is between 10-40% of the volume of the emulsion.

### Liquids

The term liquid as used in the present invention includes solid-liquid, gas-liquid, gel-liquid or liquid-liquid dispersions where the continuous phase is a liquid.

It is essential that the second liquid has an electrical conductivity less than 100 microSiemens/centimeter, and that the interfacial tension between the first liquid and the second liquid is at least 0.0001 mN/m.

Conductivity of the second liquid is preferably less than 10 microSiemens/centimeter. The interfacial tension between the liquids is preferably between 0.0001 to 5 mN/m, more preferably between 0.0001 to 1 mN/m.

Conductivity of the first liquid is preferably less than 100 milliSiemens/centimeter.

The first and the second liquid may be selected based on the type of emulsion desired. For example the first liquid may comprise water or an aqueous solution and the second liquid may comprise a water immiscible hydrophobic liquid. Conversely, the first liquid may comprise a water immiscible hydrophobic liquid and the second liquid may comprise water or an aqueous solution.

The difference in densities of the two liquids is preferably 10-2500 kg/m³, more preferably 100-2500 kg/m³. It is particularly preferred that the difference in densities of the two liquids is 50-250 kg/m³.

The two liquids according to the present invention may exhibit rheological behaviour that is Newtonian, non-Newtonian or time-dependent, Viscosity of the liquids is not a limiting factor. The process according to the invention is particularly suited to handle high viscosity liquids as compared to conventional processes. Viscosity of both the first liquid and the second liquid, measured at a shear rate of 20 s⁻¹ is preferably in the range of 0.1-100,000 cP, more preferably in the range of 0.8-10000 cP and most preferably in the range of 0.9-1000 cP. It is not envisaged that viscosities of both the liquids should be identical or fall within the identical preferred range.

### Surfactant

It is an essential feature of the present invention that at least one of the liquids comprises a surfactant or a precursor thereof.

Preferably, the surfactant is 0.01 to 20% by weight of emulsion.

Any type of surfactant can be used. Examples of zwitterionic or amphoteric or nonionic or anionic or cationic surfactants that fall within the scope of the present invention are given in the following well-known textbooks: (i) “Surface Active Agents”, Volume I by A. M. Schwartz and J. W. Perry, (ii) “Surface Active Agents and Detergents”, Volume II by A. M. Schwartz, J. W. Perry and J. Berch, (iii) “Handbook of Surfactants” by M. R. Porter, (iv) “Amphoteric Surfactants” by E. G. Lomax.

Although any surfactant may be used, it is preferred that the surfactant used is of the non-ionic, amphoteric or zwitterionic type. Suitable nonionic surfactants can be broadly described as compounds produced by the condensation of alkylene oxide groups, which are hydrophilic in nature, with an organic hydrophobic compound which may be aliphatic or alkyl aromatic in nature. The length of the hydrophilic or polyoxyalkylene radical which is condensed with any particular hydrophobic group can be readily adjusted to yield a water-soluble compound having the desired degree of balance between hydrophilic and hydrophobic elements.

Particular non-limiting examples include the condensation products of aliphatic alcohols having from 6 to 22 carbon atoms in either straight or branched chain configuration with ethylene oxide, such as a coconut oil ethylene oxide condensate having from 2 to 15 moles of ethylene oxide per mole of coconut alcohol; condensates of alkylphenols whose alkyl group contains from 6 to 22 carbon atoms with 2 to 15 moles of ethylene oxide per mole of alkylphenol; condensates of the reaction product of ethylenediamine and propylene oxide with ethylene oxide, the condensate containing from 40 to 80% of polyoxyethylene radicals by weight; tertiary amine oxides of structure R₃NO, where one group R is an alkyl group of 6 to 22 carbon atoms and the others are each methyl, ethyl or hydroxyethyl groups, for instance dimethyldodecylamine oxide; tertiary phosphine oxides of structure R₃PO, where one group R is an alkyl group of from 6 to 22 carbon atoms, and the others are each alkyl or hydroxyalkyl groups of 1 to 3 carbon atoms, for instance dimethyldodecylphosphine oxide; and dialkyl sulphoxides of structure R₂SO where the group R is an alkyl group of from 6 to 22 carbon atoms and the other is methyl or ethyl, for instance methyltetradecyl sulphoxide; fatty acid alkylolamides; alkylene oxide condensates of fatty acid alkylolamides and alkyl mercaptans.

The word “amphoteric surfactant” is used to describe surface active molecules for which the ionic character of the polar group depends on the solution pH. The word “zwitterionic surfactants” is used to describe surface active molecules that contain both positively and negatively charged groups.

Suitable amphoteric and zwitterionic surfactant compounds that can be employed are those containing quaternary ammonium, sulfonium, oxonium or phosphonium ions as cations, and carboxylate, sulfonate, sulfate, sulfite, phosphinate, phosphonite, phosphito or phosphato groups as anions.

Particular non-limiting examples of zwitterionic or amphoteric surfactants include alkyl amino acids, alkyl betaines, alkyl iminiodiacids, alkyl imidazoline derived amphoterics, alkyl poly amino carboxylates, alkyl ammonio dimethyl propyl sulfonates, phosphatidylcholines, sulfonium betaines, phosphonium betaines, sulfobetaines, sufitobetaines, sulfatobetaines, phosphinate betaines, phosphonate betaines, phosphitobetaines, phosphatobetaines and alkyl ammonio sulfonates.

### Edible Surfactants

According to one of the preferred aspects of the present invention, the surfactant used is an edible surfactant. Any edible surfactant may be used, although lipidic substances are preferred. However, the use of other, non-lipidic surfactants, for example carbohydrates, is not excluded. For food products, any edible surfactant may be used. In general the preferred edible surfactants are selected from nonionic surfactants, anionic surfactants and cationic surfactants.

Preferred non-ionic or zwitterionic edible surfactants are edible monoglycerides, diglycerides, poly-glycerol esters, non-ionic phospholipids e.g. phosphatidylcholine, non-fatty carboxylic acid esters of fatty acid esters, partial sugar-fatty acid esters and, partial fatty acid esters of polyols, alkali metal salts of fatty acids and mixtures thereof.

Preferred edible cationic surfactants are cationic non-fatty carboxylic acid esters of fatty acid esters and mixtures thereof.

Preferred edible anionic surfactants are lactylated fatty acid salts, anionic phospholipids, anionic non-fatty carboxylic acid esters of fatty acid esters and their metal salts, fatty acids and their metal salts and mixtures thereof. Some commercial surfactants, such as monoglycerides, already contain appreciably amounts of free fatty acids: in those cases it may not be necessary to add an ionic cosurfactant, if the product has a neutral or near-neutral pH.

The fatty acid chains used in these edible surfactants can be of any type and origin. Preferably, however C8-28 fatty acid chains are present, more preferred C12-22, for example C14-18. The fatty acids may for example be saturated, unsaturated, fractionated or hydrogenated and be derived from natural (for example dairy, vegetable or animal) source or synthetic sources.

Preferred edible surfactants for use in products of the invention comprise as part or all of the surfactants a material of the group monoglycerides, lecithin (or other phospholipids) and lactylated fatty acid salts.

### Precursor of Surfactant

According to another preferred aspect, a precursor of surfactant may be present in at least one of the liquids. The term precursor of surfactant as used in the present invention means a chemical precursor of surfactant that undergoes a chemical transformation by itself or by chemical reaction with a complementary reactant, to form surfactant in-situ. Preferably, the complementary reactant and surfactant precursor are not present in same liquid. It is further preferred that chemical reaction between surfactant precursor and complementary reactant does not precede subjecting of liquids to electric field. Non-limiting examples of a precursor of a surfactant include C12-C18 fatty acids for which complementary reactant includes an alkali or a base such as alkali metal hydroxide, alkali metal carbonate, and resulting surfactant is a corresponding soap. Precursor of surfactant includes acid forms of anionic surfactants such as linear C₁₂-C₁₄ alkyl benzene sulfonic acid.

### Electric Field

An electric field is applied by connecting a source of current or voltage to at least two electrodes. The term electric field strength means the potential difference measured between a pair of electrodes divided by the average distance between the electrodes, and is represented in units of V/m.

The term “dc field” as used in the present invention means a field of a constant field strength that does not vary with time. The term exposure time, when used in relation to dc field, means total duration of time during which dc field is applied.

The term “alternating field” as used in the present invention means a periodic electric field in which the field strength varies with time in a periodic manner, with any shape of waveform such as sinusoidal, triangular, square, or rectangular. Alternating fields are characterized by a frequency, an amplitude and shape of waveform. Frequency of alternating fields is preferably between 0.1 Hz-1 MHz, more preferably between 0.1-1000 Hz, most preferably between 1-200 Hz. For alternating fields, the term electric field strength means the root mean square field strength. The term exposure time, when used in relation to alternating field means total duration of time during which the field is applied.

The term pulsed field, as used in the present invention means a field that varies with time and has a waveform corresponding to a one or more pulses that can be rectangular, triangular or any other shape. The term pulse-width as used in the present invention means duration of each pulse and the term peak amplitude of pulse refers to the magnitude of electric field strength that is applied during the pulse-width. The pulsed field may comprise of pulses with different amplitudes and pulse-widths. For pulsed fields, electric field strength means the peak amplitude. The term exposure time, when used in relation to pulsed fields means the time equal to some of all pulse-widths within the total duration of time during which the pulsed field is applied.

It is one of the essential features of the present invention that the liquids are subjected to an electric field of strength between 5000 and 10⁷ V/m and preferably between 10000 and 10⁶ V/m.

The applied electric field is preferably dc, alternating, pulsed or a combination thereof. More preferably, the applied electric field is an alternating electric field.

The liquids are subjected to the electric field for an exposure time of at least 10 milliseconds, preferably at least 100 milliseconds.

### Electrodes

The electric field is applied using at least two electrodes. Distance between electrodes and the applied field can be adjusted such that the electric field strength is in the range of 5000-10⁷ V/m.

### Material of an Electrode

The electrodes can be made from any conducting material. Preferably, electrical conductivity of the conducting material is preferably greater than 0.001 Siemens/centimeter, more preferably greater than 1000 Siemens per centimeter. Particularly preferred conducting material has an electrical conductivity greater than 10⁶ Siemens/centimeter. Conducting material is not necessarily identical for all electrodes. It is within the scope of the present invention to choose different conducting materials for different electrodes

It is preferred that the conducting material of the electrode is selected from metal, graphite, conducting polymers, or conducting oxide.

The term metal as used in the present invention includes metal alloys may optionally comprise non-metals e.g. stainless steel. Examples of metals preferable as a conducting material include gold, silver, platinum, copper, aluminium and stainless steel.

Some examples of conducting polymers are, Polyacetylene doped with arsenic fluoride, polyacetylene doped with iodine. Poly(p-phenylene) doped with arsenic fluoride, Poly(pyrrole) doped with iodine, and Polyaniline (emeraldine).

Conducting material of an electrode can be selected from conducting oxides e.g. tin indium oxide.

The electrodes may also be prepared by coating of any conducting material according to the present invention on other semiconducting/dielectric/leaky dielectric materials such as polyester, PVC, glass, ceramics and polytetrafluoroethylene.

### Shape of Electrodes

Depending on various design requirements, any suitable shape of electrodes may be chosen. The shape of any of the electrodes is preferably a flat plate, an arcuate plate, a corrugated plate, a slotted plate, a hollow cylinder, a rod, or a mesh, or a combination thereof. It is not essential that all the electrodes have the same shape.

### Coating of Electrodes and Partition Between Electrodes

The electrodes can be covered partially or fully by a film or a coating of a non-conducting material. It is not essential that entire electrode surface is covered by the film or coating. The coating can be solid, liquid or semi-solid or a combination thereof.

It is preferable that a partition of a non-conducting material is placed between the electrodes.

Some non-limiting examples of non-conducting material of coating or partition include polyester, polyethylene, polypropylene, polyvinyl chloride, ceramic, glass and polytetrafluoroethylene, hydrocarbon oils, vegetable oils and alkyd resins or combinations thereof.

Other Characteristics of the Process

In the process according to the present invention, the two liquids can be contacted as independent streams whilst being subjected to the electric field. Alternatively, a preformed coarse emulsion or dispersion of the liquids can be subjected to the electric field. The term preformed coarse emulsion or dispersion as used in the present invention means an emulsion or dispersion of the liquids with large droplet size.

The process is preferably a batch process or a semi-batch process. In a batch process, a preformed coarse emulsion or dispersion of the two liquids is preferably subjected to the electric field. Alternatively, the preferred process is a continuous process. Such a continuous process may be preferably carried out in an equipment wherein the two liquids are either introduced as independent streams or as a preformed coarse emulsion or dispersion, are subjected to electric field during the contact and the resulting emulsion is continuously withdrawn from the equipment. Flowrates of the two liquids are preferably individually controlled in order to prepare an emulsion of desired volume fractions of the two liquids and to control the throughput. Liquids may be preferably introduced as coaxial jets. In a further preferred aspect, the first liquid forms the central core of the coaxial jets and the second liquid forms the annular jet.

It is preferable that the liquids are subjected to agitation during the process. Any suitable means of agitation can be used. Agitation is preferably provided by flow of at least one of said liquids, by static or moving mixing elements, by ultrasound, or by combinations thereof.

The process can be carried out at any suitable temperature. It is preferred that the temperature of each of the liquids is above its melting point when said liquids are subjected to the electric field. It is further preferred that the temperature range during the process can be between 0-100° C., preferably between 10-90° C. and more preferably between 20-70° C. The process temperature may be varied as desired by providing suitable means of heat transfer or by preheating or precooling the liquids. The process according to the present invention is preferably carried out in equipment comprising a jacket or a coil for heat transfer. According to another aspect, it is preferred that the liquids are cooled after preparing the emulsion to a temperature below the melting or gelling point of the liquid that has a higher melting or gelling point.

When a preformed coarse emulsion or dispersion of liquids is subjected to the electric field, it is preferred that the droplet diameter in the preformed coarse emulsion or dispersion is preferably smaller than the distance between electrodes.

When a jet of one liquid is introduced in the other liquid, it is preferred that the jet diameter is preferably smaller than the distance between electrodes.

The present invention will now be demonstrated with non-limiting examples. The examples are for illustration only and do not limit the scope of the invention in any manner.

### EXAMPLES

### Examples 1-6

### Process According to the Present Invention

Apparatus A glass cuvette of a the rectangular cross section (14 mm×10 mm) and a height of 50 mm was used in the following examples. A capillary tube of 2 mm diameter was attached perpendicularly to the bottom face of dimension 14 mm×10 mm, and projected outward to provide an inlet for the first liquid such that the jet issuing from the inlet pointed vertically upwards and the jet axis coincided with the vertical axis of the cuvette. A similar tube attached on the top face of dimension 14 mm× by 10 mm provided the outlet of the emulsion. Another tube of diameter 2 mm, attached perpendicularly to the lateral face of dimension 10 mm by 50 mm, provided the inlet for the second liquid. Inlet tube for the second liquid protruded inside the cuvette and was provided with a 90 degree bend to form an L-shaped tube ending in a nozzle of diameter 1 mm such that the jet issuing from the nozzle would flow in a vertically upwards direction and the jet axis would coincide with the vertical axis of the cuvette.

Flat plate stainless steel electrodes of size 35 mm×5 mm and thickness 2 mm were glued flush to the two inner lateral walls of dimension 10 mm by 50 mm such that the perpendicular distance between the electrodes was 10 mm. The top edge of the electrode was 5 mm from the top face and the bottom edge of the electrodes was 10 mm from the bottom face. The inlets for the first and the second liquids were connected to the corresponding liquid reservoirs through different peristaltic pumps in such a way that the flowrate of each of the liquids could be independently adjusted. Flowrate of first liquid could be variably fixed in the range 1-15 mL/min and flowrate of the second liquid could be variably fixed in the range 40-80 mL/min. Electrodes were connected to a power supply of 5000 V (root mean square voltage), 50 Hz AC.

In the examples, following liquids were used

### The First Liquid

| | | |
|---|---|---|
| Composition | MilliQ water | 99% by weight |
| | Tween80 | 1% by weight |

| | |
|---|---|
| Conductivity | 40 microSiemens/cm |
| Viscosity (at 20 s⁻¹) | 1 cP |
| Temperature | 60° C. |

### The Second Liquid

Composition

| | | |
|---|---|---|
| Hydrogenated vegetable oil | 97% | by weight |
| (Dalda supplied by Bunge) | | |
| Glycerol Mono Stearate | 3% | by weight |
| Conductivity | <1 | microSiemens/cm |
| Viscosity (at 20 s⁻¹) | 200 | cP |
| Temperature | 60° | C. |

Interfacial tension between the two liquids was measured using spinning drop tensiometer, Kruss and found to be 0.2 mN/m

The liquids were subjected to the electric field of strength 5×10⁵ V/m for various amounts of exposure time depending upon the flowrates of the first and the second liquid.

Examples of processes carried out at various flowrates of liquids are given in Table 1.

TABLE 1
Details of processes according to the present invention (examples 1-6)

| | Flowrate | Flowrate | Flowrate | Exposure time | | Time required | Energy |
|---|---|---|---|---|---|---|---|
| | of second | of first | of emulsion | to electric | | for processing | consumption |
| Ex | liquid | liquid | prepared | field | Power | 100 mL | (J/100 mL of |
| No | (mL/min) | (mL/min) | (mL/min) | (seconds) | (Watts) | (seconds) | emulsion) |
| 1 | 50 | 5 | 55 | 1.6 | 60 | 109 | 6540 |
| 2 | 60 | 6 | 66 | 1.4 | 60 | 91 | 5460 |
| 3 | 70 | 6 | 76 | 1.2 | 60 | 79 | 4740 |
| 4 | 80 | 8 | 88 | 1.0 | 60 | 68 | 4080 |
| 5 | 60 | 8 | 68 | 1.3 | 60 | 88 | 5280 |
| 6 | 80 | 10 | 90 | 1.0 | 60 | 67 | 4020 |

Mean droplet size of all the emulsions formed was measured using cryo-SEM.

Characteristics of resulting emulsion are given in Table 2

TABLE 2
Characteristics of emulsions of examples 1-6

| | % Volume of | Total surfactant | |
|---|---|---|---|
| | first liquid | (glycerol mono- | |
| | by volume of | stearate + | Mean |
| | the emulsion | Tween 80) (wt % | Drop Size |
| Example no | formed | of the emulsion) | (microns) |
| 1 | 10.0 | 2.82 | 1-5 microns |
| 2 | 10.0 | 2.82 | 1-5 microns |
| 3 | 8.6 | 2.84 | 1-5 microns |
| 4 | 10.0 | 2.82 | 1-5 microns |
| 5 | 13.3 | 2.76 | 1-5 microns |
| 6 | 12.5 | 2.78 | 1-5 microns |

### Comparative Example A

### Process Using a Laboratory Homogenizer

The first and the second liquid compositions were same as in Examples 1-6. The two liquids (5 mL of the first liquid and 45 mL of the second liquid) were processed in a high-speed homogenizer (Polytron, PT-K Kinematicaa AG) and run at 30000 rpm for 10 minutes. The volume of resulting emulsion was 50 mL. Mean droplet size was 4-6 microns. Volume of the first liquid was 10% of the emulsion volume.

Energy requirements was 126000 J/100 mL of emulsion

### Comparative Example B

### Process Using a Silverson Mixer

The first and the second liquid compositions were same as in Examples 1-6. The two liquids (10 mL of the first liquid and 90 mL of the second liquid) were processed in a Silverson mixer at 60000 rpm for 15 minutes. The volume of resulting emulsion was 100 mL. Mean droplet size was 6-9 microns. Volume of the first liquid was 10% of the emulsion volume.

Energy requirement was 67200 J/100 mL of emulsion.

A comparison of energy requirement and droplet size of resulting emulsions for process of examples 1-6 that falls within the scope of the present invention and processes of comparative examples A and B that are not within the scope of the present invention is given in Table 3 below

TABLE 3
Comparison of processing time and energy requirements

| | | Energy | |
|---|---|---|---|
| | Time required | consumption | Mean |
| | for processing | (J/100 mL of | droplet size |
| Example no | 100 mL (seconds) | emulsion) | (microns) |
| 1 | 109 | 6540 | 1-5 |
| 2 | 91 | 5460 | 1-5 |
| 3 | 79 | 4740 | 1-5 |
| 4 | 68 | 4080 | 1-5 |
| 5 | 88 | 5280 | 1-5 |
| 6 | 67 | 4020 | 1-5 |
| Ex A | 600 | 126000 | 4-6 |
| Ex B | 900 | 67200 | 6-9 |

From the above Table 3, it is clear that the process according to the present invention is more energy efficient as compared to the conventional processes. Process of the present invention is also faster and provides emulsions that have a small droplet size.

1. A process for preparing an emulsion of a first liquid in a second liquid wherein
(a) at least one of the liquids comprises a surfactant or a precursor thereof, and
(b) said second liquid has an electrical conductivity of less than 100 microSiemens/centimeter, and
(c) interfacial tension between said liquids is at least 0.0001 mN/m, and
(d) said liquids are subjected to an electric field of strength between 5000 to 10⁷ V/m.

2. A process for preparing an emulsion as claimed in claim 1 wherein said surfactant is nonionic, amphoteric or zwitterionic.

3. A process for preparing an emulsion as claimed in claim 1 wherein said surfactant is 0.01 to 20% by weight of said emulsion.

4. A process for preparing an emulsion as claimed in claim 1 wherein said interfacial tension is between 0.0001 to 5 mN/m.

5. A process for preparing an emulsion as claimed in claim 1 wherein said electric field is alternating, dc or pulsed or a combination thereof.

6. A process for preparing an emulsion as claimed in claim 1 wherein said liquids are subjected to said electric field for an exposure time of at least 10 milliseconds.

7. A process for preparing an emulsion as claimed in claim 6 wherein said exposure time is at least 100 milliseconds.

8. A process for preparing an emulsion as claimed in claim 1, a preformed coarse emulsion or dispersion of said liquids is subjected to said electric field.

9. A process for preparing an emulsion as claimed in claim 1 wherein electrical conductivity of said second liquid is less than 10 microSiemens per centimeter.

10. A process for preparing an emulsion as claimed in claim 1 wherein electrical conductivity of said first liquid is less than 100 microSiemens per centimeter.

11. A process for preparing an emulsion as claimed in claim 1 wherein said electric field is applied using at least two electrodes.

12. A process for preparing an emulsion as claimed in claim 1 wherein said electrodes are made of a conducting material.

13. A process for preparing an emulsion as claimed in claim 12 wherein said conducting material is selected from metal, graphite, conducting polymers, or conducting oxide.

14. A process for preparing an emulsion as claimed in claim 1 wherein shape of any of said electrodes is a flat plate, an arcuate plate, a corrugated plate, a slotted plate, a hollow cylinder, a rod, or a mesh, or a combination thereof.

15. A process for preparing an emulsion as claimed in claim 1 wherein one or more of said electrodes are covered by a film or a coating of a non-conducting material.

16. A process for preparing an emulsion as claimed in claim 1 wherein a partition of a non conducting material is placed between said electrodes.
